(19) United States
(12) Patent Application Publication
(10) Pub. No.: US 2014/0195072 A1
(43) Pub. Date: Jul. 10, 2014

(54) INTER-VEHICLE COMMUNICATIONS

(71) Applicant: David L. Graumann, Portland, OR (US)

(72) Inventor: David L. Graumann, Portland, OR (US)

(21) Appl. No.: 13/977,539

(22) PCT Filed: Dec. 29, 2011
(86) PCT No.: PCT/US2011/067853

§ 371 Date: Mar. 19, 2014

(51) Int. Cl. G08G 1/00; H04B 7/26

(52) U.S. Cl. CPC G08G 1/22; H04B 7/26
USPC 701/2; 455/66.1

(57) ABSTRACT

Methods, systems, and apparatus are provided for communicating between one or more vehicles, including providing communicated information to a user of the one or more vehicles. The information may be presented to the user via one or more user interfaces.

### TECHNICAL FIELD

This invention generally relates to communications, and more particularly to communications between vehicles.

### BACKGROUND

Modern vehicles may include a variety of sensors for enhancing the safety, convenience, usability, or the like for the user of the vehicle. Some of the sensors may be provided on the inside of the vehicle, and others may be provided on an external surface of the vehicle. Information from the sensors may be processed and provided to the user, such as the driver, of the vehicle. In-vehicle infotainment (IVI) systems are often provided on vehicles, such as cars, to provide the users and occupants of the vehicle with entertainment and information. The IVI system may include one or more computers or processors coupled to a variety of user interfaces. The IVI system may be part of the vehicle's main computer or a stand-alone system that may optionally be coupled to the vehicle's main computer. The user interfaces may be any one of speakers, displays, keyboards, dials, sliders, or any suitable input and output element. The IVI system, therefore, may use any variety of user interfaces to interact with a user of the system, such as a driver of the vehicle. The information provided by the IVI system or any other suitable user interface system of the vehicle may include the information ascertained from the sensors.

Sensor data may include navigation data, such as global positioning satellite (GPS) information. Such information may be displayed by the IVI system on the one or more user interfaces. In some aspects, the user, such as the driver of the vehicle, may select or pre-configure what information to display on the one or more user interfaces.

Multiple vehicles on the road may be configured for collecting sensor data related to the position of the vehicle to one or more adjacent vehicles using ranging sensors, such as radio detecting and ranging (RADAR), a sound navigation and ranging (SONAR), or light detecting and ranging (LIDAR).

### BRIEF DESCRIPTION OF THE FIGURES

Reference will now be made to the accompanying drawings, which are not necessarily drawn to scale, and wherein:

FIG. 1 is a simplified schematic diagram illustrating an example roadway system with a plurality of vehicles thereon communicating with each other in accordance with various embodiments of the disclosure.

FIG. 2 is a simplified physical block diagram illustrating an example system for interpreting and controlling inter-vehicle communications in accordance with various embodiments of the disclosure.

FIG. 3 is a simplified functional block diagram corresponding to the example system and physical block diagram of FIG. 2 illustrating examples of interpreting and controlling inter-vehicle communications in accordance with various embodiments of the disclosure.

FIG. 4 is a simplified flow diagram illustrating an example method for interpreting and controlling inter-vehicle communications in accordance with various embodiments of the disclosure.

### DETAILED DESCRIPTION OF EMBODIMENTS OF THE INVENTION

Embodiments of the disclosure are described more fully hereinafter with reference to the accompanying drawings, in which certain embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the disclosure provide systems, methods, and apparatus for communicating information, such as sensor information, between one or more vehicles. The sensor information may include, for example, navigation information, such as global positioning satellite (GPS)-based navigation information and/or range sensor information. Therefore, a vehicle may determine a range between any two vehicles, including two other vehicles, on the road. Additionally, an occupant of the vehicle may be presented with a wide variety of suitable awareness information associated with other vehicles. Information may be communicated between vehicles using one or more communicative channels. In certain embodiments, the communicative channel may entail modulated light transmitted from one vehicle and detected by one or more image sensors on another vehicle. In one aspect, modulated light may be generated using any one of the signaling lights provided on a vehicle, such as one or more brake lights. Further, it may be determined what information received by a vehicle from another vehicle should be transmitted to a subsequent vehicle considering the communicative channel bandwidth and other physical considerations. Therefore, a vehicle may receive information from another vehicle and process the information for display within the vehicle and/or for controlling one or more components within the vehicle. The vehicle receiving the information from another vehicle may further process the information and communicate all or a subset of the information to yet another vehicle. As a result, a user of a vehicle receiving sensor and other information from another vehicle may have additional information for controlling the vehicle, which may, therefore, enhance safety or convenience during driving.

Example embodiments of the disclosure will now be described with reference to the accompanying figures.

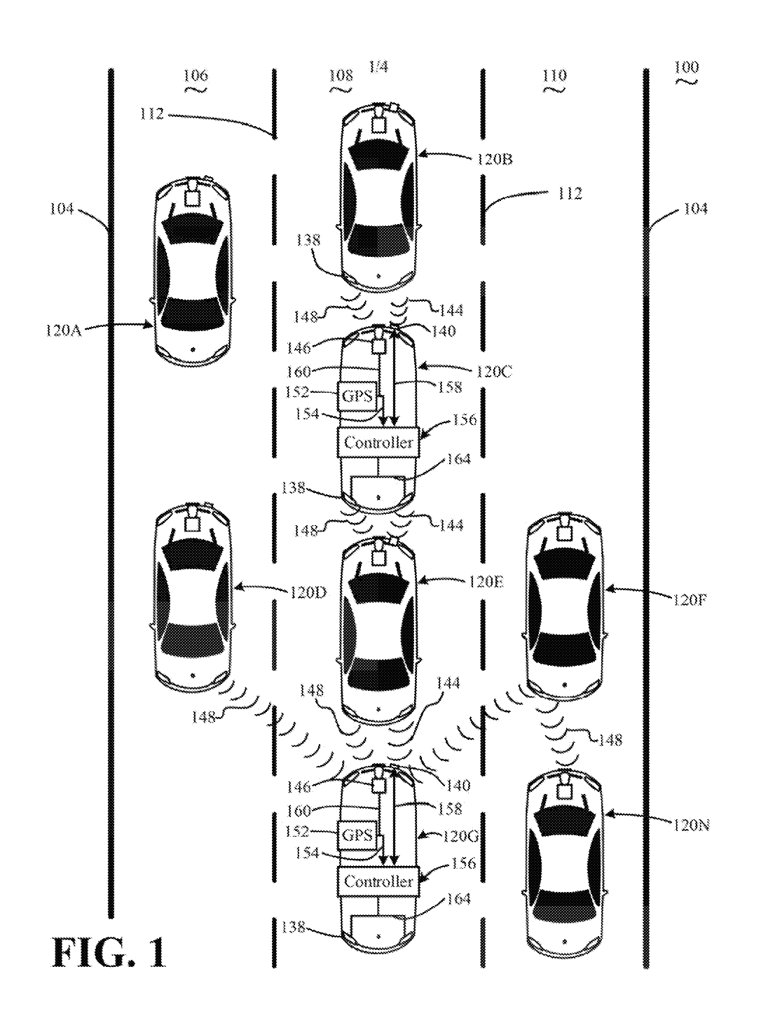

Referring now to FIG. 1, an example roadway system 100 is illustrated. The system 100 may include a plurality of vehicles 120A-N driving on a road bound by the edges of the road 104 and separated into three lanes 106, 108, and 110 demarcated by lane markers 112. Each of the vehicles 120A-N may have one or more signaling lights 138, depicted as tail lights, at least one range sensor 140, and at least one image sensor 146. Each of the one or more signaling lights 138 may be configured to emit radiation 148 that may be detected by an image sensor 146. Each of the range sensors 140 may be configured to emit a wave 144 to determine the range between the range sensor 140 and another object, such as another vehicle 120 A-N, in front of the vehicle to which the range sensor 140 is associated. In the system 100, one or more of the vehicles 120A-N may communicate with each other via messages output by the signaling lights 138 and detected by the image sensors 146. Each of the vehicles 120A-N may further include a navigation system 152, such as a GPS navigation system, communicatively coupled via communicative link 154 to a controller 156; communicative link 158 communicatively coupling the range sensor(s) 140 with the controller 156; communicative link 160 communicatively coupling the image sensor 146 with the controller 156; and communicative link 164 communicatively coupling the one or more signaling lights 138 to the controller 156.

For the purposes of this discussion, the one or more vehicles 120A-N may include, but are not limited to, cars, trucks, light-duty trucks, heavy-duty trucks, pickup trucks, minivans, crossover vehicles, vans, commercial vehicles, private vehicles, sports utility vehicles, tractor-trailers, or any other suitable vehicle with communicative and sensory capability. However, it will be appreciated that embodiments of the disclosure may also be utilized in other transportation or non-transportation related applications where electronic communications between two systems may be implemented.

The one or more signaling lights 138, although depicted as tail lights, may be any suitable signaling lights, including, but not limited to, brake lights, reverse lights, headlights, side lights, mirror lights, fog lamps, low beams, high beams, add-on lights, or combinations thereof. In certain embodiments, the one or more signaling lights 138 may include one or more light-emitting elements (not shown). The light-emitting elements may include, but are not limited to, light-emitting diodes (LEDs), incandescent lamps, halogen lamps, fluorescent lamps, compact fluorescent lamps, gas discharge lamps, light amplification by stimulated emission of radiation (lasers), diode lasers, gas lasers, solid state lasers, or combinations thereof. Additionally, the one or more signaling lights 138 may emit radiation 148 at any suitable wavelength, intensity, and coherence. In other words, the radiation 148 may be monochromatic or polychromatic and may be in the near ultraviolet (near-UV), infrared (IR), or visible range, from about 380 nanometers (nm) to 750 nm wavelength range. As a non-limiting example, the one or more signaling lights 138 may include a tail light of the vehicles 120A-N that includes a plurality of LEDs. The plurality of LEDs may be, for example, Indium Gallium Aluminum Phosphide (InGaAlP) based LEDs emitting radiation at about 635 nm wavelength. In other examples, the one or more signaling lights 138 may include two tail lights, or two tail lights and a brake light. In certain embodiments, non-visible radiation 148, such as infrared radiation, may be emitted by the one or more signaling lights 138, so that an observer does not confuse the radiation 148 with other indicators, such as the application of brakes.

In certain embodiments, each of the light-emitting elements of a particular signaling light 138 may be turned on and off at the same time. For example, all of the LEDs of a particular signaling light 138 may turn on or off at the same time. In other embodiments, a portion of the light-emitting elements may be turned on and off at the same time. In certain aspects, the one or more signaling lights 138 may be configured to be modulated at a frequency in the range of about 10 Hertz (Hz) to about 100 megahertz (MHz). The one or more signaling lights 138 and the resulting radiation 148 may be modulated using any suitable scheme. In certain embodiments, the modulation technique may be pulse code modulation (PCM). Alternatively, the radiation 148 may be modulated using pulse width modulation (PWM), amplitude modulation (AM), quadrature amplitude modulation (QAM), frequency modulation (FM), phase modulation (PM), or the like. In certain embodiments, multiple copies of the same information may be transmitted via the radiation 148 to ensure receipt of the same by a receiver. Additionally, information encoded onto the radiation 148 may include cyclic redundant checks (CRC), parity checks, or other transmission error checking information.

In certain embodiments, the one or more signaling lights 138 may include two or more signaling lights, each signaling light having one or more emitting elements. The emitting elements from all the signaling lights may be modulated with the same signal and turn on and turn off at the same time. As a non-limiting example, consider that two tail lights are modulated with the same signal and, therefore, both the tail lights turn on and turn off contemporaneously. This type of modulation scheme may require observation of only one of the two or more signaling lights to receive the modulated signal. Having one or more signaling lights 138 emitting the same signal on both signaling lights 138 may improve the ability of an observer to observe the radiation 148 coming therefrom. For example, consider that a first vehicle provides modulated radiation 148 from tail lights on both sides at the rear of the first vehicle. If a second vehicle, behind the first vehicle within a lane 106, 108, and 110, is positioned such that the image sensor 146 on the second vehicle cannot observe one of the tail lights, it may still detect the radiation emanating from the other tail light. Therefore, by having multiple signaling lights 138, the angle from which the radiation 148 may be viewed may be increased for a particular image sensor 146 relative to a situation where there is only one signaling light 138. Additionally, having more than one signaling light 138 may provide a more robust observation of the radiation 148 emitted therefrom. In other words, by having more than one signaling light 138, the amplitude of the overall radiation 148 emitted from the more than one signaling light 138 may be greater than if only one signaling light 138 is used. As a result, the observation of the overall radiation 148 resulting from more than one signaling light 138 may provide a relatively greater signal-to-noise ratio than if only one signaling light 138 is used.

In certain other embodiments, the one or more signaling lights 138 may include two or more signaling lights, each signaling light having one or more emitting elements and each signaling light providing a different radiation therefrom. For example, a vehicle may use tail lights on both sides at the rear of the vehicle, where the radiation emitted from one of the tail lights is different from the radiation emitted from the other tail light. The difference in the radiation emitted may be one or more of the magnitude, the phase, the modulated frequency, or the wavelength. Emitting different radiation from each of the tail lights may, in one aspect, enable providing a combined signal associated with the one or more different radiation emissions that can enable a variety of modulation and multiplexing schemes. This concept may be illustrated by way of example. Consider the example from above where a vehicle may provide two different radiation emissions corresponding to two different tail lights. If the two different radiation emissions have different wavelengths, then wavelength division multiplexing (WDM) techniques may be used for encoding information onto the radiation emissions. If, however the two different radiation emissions are phase-shifted from each other, then PM techniques may be used for encoding information onto the radiation emissions. Further yet, if the two radiation emissions are different modulated frequencies from each other, then yet other modulation and multiplexing schemes may be enabled. In one aspect, the different radiation emissions from each signaling light may be observed to demodulate or demultiplex information carried via the combination of the different radiation emissions.

In yet other embodiments, different emitting elements within a single signaling light 138 may emit different radiation therefrom. As a result, the signals emitted from a single signaling light 138 may enable a variety of modulation and multiplexing schemes that rely on more than one channel of transmission. For example, a single signaling light 138 may include a first set of LEDs that emit radiation at a first wavelength and a second set of LEDs that emit radiation at a second wavelength. If an observer, such as the image sensor 146, observes the combined radiation from the single signaling light 138 and can discriminate between the first and second wavelengths, then the emissions at the first wavelength and the second wavelength may serve as two independent channels, thereby enabling, for example, WDM. As a further example, consider a single signaling light 138 that may include a first set of LEDs that emit a radiation signal at a first phase and a second set of LEDs that emit a radiation at a second phase. If an observer, such as the image sensor 146, observes the combined radiation from the single signaling light 138 and can discriminate between the first and second phases, then the emissions at the first phase and the second phase may serve as two independent channels, thereby enabling, for example, QAM. In one aspect, the signal with the first phase may be orthogonal to the signal with the second phase.

It can be seen that certain other embodiments may include multiple signaling lights, where each signaling light may provide radiation that can carry more than one independent channel. For example, two tail lights may each provide two distinct wavelengths of radiation emission. This scenario may enable multichannel multiplexing techniques, such as WDM, in addition to providing a wider radiation pattern that can be viewed from a relatively greater range of viewing angles than in a scenario with a single signaling light.

Additionally, more than one signaling light may be used for the purpose of communicating with more than one vehicle. For example, signaling lights on the rear of a particular vehicle may be used for communicating to other vehicles behind the vehicle, and signaling lights on the side of the vehicle may be used for communicating to other vehicles in adjacent lanes to the lane with the vehicle. Furthermore, different information may be provided to different other vehicles. For example, information communicated to another vehicle to the side of the particular vehicle may receive different information than another vehicle in front of the vehicle. As a further example, vehicles to the side of the particular vehicle may receive information such as lane change information of vehicles to the front of the vehicle, while vehicles behind the particular vehicle may receive information related to speed and acceleration of other vehicles in front. In certain embodiments, the information provided to another vehicle may be targeted in particular to the other vehicle.

It should be noted that the one or more signaling lights 138 may be used for purposes other than carrying a modulated signal over the radiation 148. For example, a vehicle (generally referred to as vehicle 120) may provide the radiation 148 via the tail lights on both sides at the rear of the vehicle 120. The tail lights may be used for indicating that the driver of the vehicle 120 has applied the vehicle's brakes in addition to emitting radiation 148. In certain embodiments, the one or more signaling lights 138 may not be used for multiple purposes contemporaneously. For example, tail lights being used for indicating that the vehicle has brakes applied may preclude the tail lights from emitting radiation 148 carrying a communication signal.

In other embodiments, the one or more signaling lights 138 may be used for multiple purposes contemporaneously. For example, tail lights being used for indicating that the vehicle has brakes applied may also emit radiation 148 carrying a communication signal. In these embodiments, the radiation emissions from the one or more signaling lights 138 may be superimposed. For example, with a lit tail light indicating that a vehicle's 120 brakes are applied, the communicative signal may be superimposed, where the overall radiation from the tail light may vary from a first nonzero magnitude to a second nonzero magnitude based on the communicative signal. In other words, indication of the brakes being applied may provide a baseline magnitude of radiation, and the communicative signal may be applied as a small signal superimposed on the baseline magnitude.

In certain other embodiments, the one or more signal lights 138 may use time division multiplexing (TDM) for purposes of emitting radiation therefrom with multiple purposes, such as indicating that a vehicle has brakes applied and providing a communicative channel thereon. In yet other embodiments, the one or more signal lights 138 may use wavelength division multiplexing (WDM) for purposes of emitting radiation therefrom with multiple purposes, such as indicating that a vehicle has brakes applied and providing a communicative channel thereon. In certain embodiments, the bandwidth of a communicative channel carried on the emitted radiation 148 may vary based upon whether the one or more signal lights 138 from which the radiation 148 originates is emitting radiation other than the radiation 148 for communicative purposes.

The image sensor 146 may be any known device that converts an optical image or optical input to an electronic signal. The image sensor 146 may be of any known variety including a charge-coupled device (CCD), complementary metal oxide semiconductor (CMOS) sensors, or the like. The image sensor 146 may further be of any pixel count and aspect ratio. Furthermore, the image sensor 146 may be sensitive to any frequency of radiation, including infrared, visible, or near-ultraviolet (UV). In certain embodiments, the image sensor 146 may be sensitive to and, therefore, be configured to detect the wavelength of light emitted from the one or more signaling lights 138.

In embodiments where the one or more signal lights 138 emit more than one wavelength, the image sensor 146 may sense both wavelengths and be configured to provide a signal indicative of both wavelengths. In other words, the image sensor 146 may be able to sense the radiation 148 and discriminate between more than one wavelength contained therein. In one aspect, the image sensor 146 may provide an image sensor signal that indicates the observation of the radiation 148. The image sensor signal may be an electrical signal. In certain embodiments, the image sensor signal may be a digital signal with discretized levels corresponding to an image sensed by the image sensor 146. In other embodiments, the image sensor signal may be an analog signal with continuous levels corresponding to an image sensed by the image sensor 146.

In certain embodiments, the image sensor 146 may be configured to sample the radiation at a rate that is at least twice the frequency of any signal, such as a communications signal, with which the radiation emission is modulated. In other words, the frame rate of the image sensor 146 may be at a rate sufficient to meet the Nyquist-Shannon criterion associated with signals modulated onto the radiation 148 and emitted by the one or more signal lights 138.

The range sensor 140 may be of any known variety including, for example, an infrared detector. In one aspect, the range sensor 140 may include a wave emitter (not shown) for generating and emitting the wave 144. The wave 144 may be infrared radiation that may reflect off of an object, such as the vehicle in front of the range sensor 140, and the reflected radiation may be detected by the range sensor 140 to determine a range or distance between the range sensor 140 and the object. For example, the emitter may emit infrared radiation that may reflect off of the vehicle in front of the range sensor 140. The reflected radiation may then be detected by the range sensor 140 to determine the distance between the range sensor 140 and the vehicle.

In certain embodiments, the range sensor 140 may be a light detection and ranging (LIDAR) detector. In such an implementation, the emitter may be an electromagnetic radiation emitter that emits coherent radiation, such as a light amplification by stimulated emission of radiation (laser) beam at one or more wavelengths across a relatively wide range, including near-infrared, visible, or near-ultraviolet (UV). In one aspect, the laser beam may be generated by providing the laser with electrical signals. The LIDAR detector may detect a scattered laser beam reflecting off of an object, such as the vehicle in front of the range sensor 140, and determine a range to the object. In one aspect, the LIDAR detector may apply Mei solutions to interpret scattered laser light to determine range based thereon. In other aspects, the LIDAR detector may apply Rayleigh scattering solutions to interpret scattered laser light to determine range based thereon.

In certain other embodiments, the range sensor 140 may be a radio detection and ranging (RADAR) detector. In such an implementation, the emitter may be an electromagnetic radiation emitter that emits microwave radiation. In one aspect, the emitter may be actuated with electrical signals to generate the microwave radiation. The microwave radiation may be of a variety of amplitudes and frequencies. In certain embodiments, the microwave radiation may be mono-tonal or have substantially a single frequency component. The RADAR detector may detect scattered microwaves reflecting off of an object, such as the vehicle in front of the range sensor 140, and determine a range to the object. In one aspect, the range may be related to the power of the reflected microwave radiation. RADAR may further use Doppler analysis to determine the change in range between the range sensor 140 and the object. Therefore, in certain embodiments, the range sensor 140 may provide both range information, as well as information about the change in range to an object.

In yet certain other embodiments, the range sensor 140 may be a sound navigation and ranging (SONAR) detector. In such an implementation, the emitter associated with the range sensor 140 may be an acoustic emitter that emits compression waves at any frequency, such as frequencies in the ultra-sonic range. In one aspect, the emitter may be actuated with electrical signals to generate the sound. The sound may be of a variety of tones, magnitudes, and rhythm. Rhythm, as used herein, is a succession of sounds and silences. In one aspect, the sound may be a white noise spanning a relatively wide range of frequencies with a relatively consistent magnitude across the range of frequencies. Alternatively, the sound may be pink noise spanning a relatively wide range of frequencies with a variation in magnitude across the range of frequencies. In yet other alternatives, the sound may be mono-tonal or may have a finite number of tones corresponding to a finite number of frequencies of sound compression waves. In certain embodiments, the emitter may emit a pulse of sound, also referred to as a ping. The SONAR detector may detect the ping as it reflects off of an object, such as the vehicle, and determine a range to the object by measuring the time it takes for the sound to arrive at the range sensor 140. In one aspect, the range may be related to the total time it takes for a ping to traverse the distance from the emitter to the object and then to the range sensor 140. The determined range may be further related to the speed of sound. SONAR may further use Doppler analysis to determine the change in range between the range sensor 140 and an obstruction. Therefore, in certain embodiments, the range sensor 140 may provide both range information, as well as information about the change in range to an object.

While the one or more signaling lights 138 have been depicted at the rear of each of the vehicles 120A-N, the one or more signaling lights 138 may be provided at any suitable location on the vehicles 120A-N. For example, the one or more signaling lights 138 may be provided at one or more of the front, the sides, the rear, the top, or the bottom of the vehicles 120A-N. Similarly, while the image sensor 146 has been depicted at the front of each of the vehicles 120A-N, the image sensor 146 may be provided at any suitable location on the vehicles 120A-N, including, but not limited to, the front, the sides, the rear, the top, or the bottom of the vehicles 120A-N.

The navigation system 152 may receive any one of known current global navigation satellite signal (GNSS) or planned GNSS, such as the Global Positioning System (GPS), the GLONASS System, the Compass Navigation System, the Galileo System, or the Indian Regional Navigational System. The navigation system 152 may receive GNSS from a plurality of satellites broadcasting radio frequency (RF) signals, including satellite transmission time and position information. According to certain embodiments, the navigation system 152 may receive satellite signals from the three or more satellites and may process the satellite signals to obtain satellite transmission time and position data. The navigation system 152 may process the satellite time and position data to obtain measurement data representative of measurements relative to the respective satellites and may process the measurement data to obtain navigation information representative of at least an estimated current position of the navigation system 152. In one embodiment, the measurement data can include time delay data and/or range data, and the navigation information can include one or more of position, velocity, acceleration, and time for the navigation system 152.

While the navigation system 152 has been depicted as a GPS navigation system, the navigation signal with location and/or time information may be obtained from any suitable source, including, but not limited to, Wireless Fidelity (Wi-Fi) access points (APs), inertial navigation sensors, or combinations thereof. The inertial navigation sensors may include, for example, accelerometers or gyros, such as micro-electromechanical systems (MEMS) based accelerometers. For illustrative purposes, the remainder of the disclosure will depict the navigation signal source as GNSS from satellites, but it will be appreciated that embodiments of the disclosure may be implemented utilizing any suitable source of navigation signal. In certain embodiments, multiple sources of navigation signals may be utilized by the systems and methods described herein.

In other aspects, the communicative links 154, 158, 160 and 164 may include any number of suitable links for facilitating communications between electronic devices. The communicative links 154, 158, 160 and 164 may be associated with vehicle 120A-N communications infrastructure, such as a car data bus or a controller area network (CAN). Alternatively, the communicative links 154, 158, 160, and 164 may include, but are not limited to, a hardwired connection, a serial link, a parallel link, a wireless link, a Bluetooth® channel, a ZigBee® connection, a wireless fidelity (Wi-Fi) connection, a proprietary protocol connection, or combinations thereof. In one aspect, the communicative links 154, 158, 160, and 164 may be secure so that it is relatively difficult to intercept and decipher communication signals transmitted on the links 154, 158, 160, and 164.

In operation, the example vehicles 120A-N may communicate between each other utilizing the one or more signal lights 138 and the image sensor 146. In one aspect, the image sensor 146 of a particular vehicle may sense the radiation 148 from another vehicle and generate an image sensor signal indicative of communication signals modulated onto the detected radiation 148. The image sensor signal may be transmitted by the image sensor 146 to the controller 156 via the communicative link 160. The controller 156 may analyze the image sensor signal and determine the communication signal therefrom. The controller 156 may analyze the communication signal received from the other vehicle and determine if the information should be presented to the user, such as the driver, of the vehicle. Therefore, the controller 156 may provide signals to one or more user interfaces to provide information associated with the communication signal to the user, such as the driver, of the vehicle.

The controller 156 may also, optionally, receive navigation information from the navigation system 152 via communicative link 154. Further, the controller 156 may also, optionally, receive range sensor signals from the range sensor 140 via communicative link 158. The controller 156 may analyze the additional navigation information from the navigation system 152, the range information from the range sensor 140 and vehicle information and determine information, such as traffic and navigation information, that should be presented to the user, such as the driver, of the vehicle. Vehicle information may include, but is not limited to, cruise control settings, speed, acceleration, or the like. In one aspect, the controller 156 may provide signals corresponding to the information that is deemed to be presented to the user by a user interface that may be sensed or observed by the user of the vehicle.

In certain embodiments, the controller 156 may ascertain which subset of information, from the total information provided to the controller 156 from the communicative signal, as well as the navigation signal and the range sensor signal, to present to the user of the vehicle 120, such as the driver. After determining the subset of information, the controller 156 may provide the subset of information to the user of the vehicle 120 via one or more user interfaces.

Continuing on with the communications between the vehicles 120A-N, the controller 156 of a particular vehicle may have a collection of information related to the road, navigation, traffic, and/or any other information that may be sensed by the vehicle or by other vehicles with which the vehicle is communicating. From the full collection of information that the controller 156 of the vehicle has available to it, the controller 156 may determine a subset of the full collection of information to communicate to another vehicle and/or to output for presentation to a user. The determination by the controller 156 of what information should be communicated to another vehicle may consider what information may be useful for operating the vehicles 120A-N to which the information will be sent. The determination may further entail consideration of the bandwidth of the communications channel utilized. For example, the controller 156 may rank order which information available to it from the image sensor 146, the range sensor 140, and the navigation system 152 may be most useful for the operation of the other vehicle. Then the controller 156 may select information according to the rank order up to the information that can be transmitted given any bandwidth limitations of the communications channel, where the channel may be bandwidth limited by the communications between the one or more signaling lights 138 of the vehicle and the image sensor 146 of the vehicle with which the controller 156 is communicating. In certain aspects, the controller 156 may generate the signal corresponding to a subset of the full set of information available to the controller 156 that is provided to the one or more signaling lights 138 to generate the radiation 148 for communicating to another vehicle.

In certain embodiments, if the amount of information is such that the full collection of information available to the controller 156 may be transmitted to another vehicle, then the controller 156 may generate a signal to modulate the one or more signaling lights 138 with a signal corresponding to the full collection of information available to the controller 156. Therefore, if the full amount of information available to the controller 156 from various sources, such as the image sensor 146, the range sensor 140, and the navigation system 152 of the vehicle, is less than a bandwidth threshold, then the full set of information may be communicated by the controller 156 to another vehicle. If the bandwidth of the channel, including at least the communicative link 164, as well as the one or more signaling lights 138, the radiation 148, the image sensor 146 on the other vehicle, and the communicative link 160 on the other vehicle, is greater than that required to transmit the full set of information, then the full set of information may be communicated by the controller 156 to the other vehicle.

As an illustrative example, consider that vehicle 120C receives a communication signal via the radiation 148 from vehicle 120B, and the radiation 148 is sensed by the image sensor 146 on vehicle 120C, generating an image sensor signal that is provided to the controller 156 of the vehicle 120C. The communication signal may include information associated with navigation information or range information associated with vehicle 120B or other vehicles 120A-N on which vehicle 120B has information. The vehicle 120C may further receive navigation signals via the navigation system 152 of vehicle 120C and communicate the navigation signals to the controller 156 of vehicle 120C. The vehicle 120C may yet further receive range information from the range sensor 140 associated with vehicle 120C, and the range information may be communicated to the controller 156 of vehicle 120C. The controller 156 may then ascertain which of the data that it has available may be most useful to the user of vehicle 120C. For example the controller may determine that the range between vehicles 120C and 120B, as determined by range sensor 140 and vehicle 120C, may be of value to the user of vehicle 120C. The controller 156 of vehicle 120C may further determine that the acceleration data from the navigation information of vehicle 120B may also be of value to the user of vehicle 120C. Therefore, the controller 156 of vehicle 120C may generate user interface signals that may make the user of vehicle 120C aware of the information that may be deemed most relevant to the user, namely the acceleration information of vehicle 120B and the range information between vehicles 120B and 120C.

It should be noted that the controller 156 of vehicle 120C may have information from the various sources, such as the GPS 152, the image sensor 146, and the range sensor 140, that may not be provided to the user of vehicle 120C. In certain aspects, the information that the controller 156 of vehicle 120C may have available that is not provided to the user of vehicle 120C may be information that is deemed by the controller and software running thereon as being relatively less useful to the user, such as the driver, of vehicle 120C. For example, the controller 156 of vehicle 120C may have information on the range between vehicle 120B and any vehicles in front of vehicle 120B. However, this information may not be as useful to the driver of vehicle 120C as, for example, information on the range between vehicle 120C and vehicle 120B and, therefore, may not be displayed to the driver of vehicle 120C.

Continuing on with the preceding example, the controller 156 of vehicle 120C may also determine what information that it has available should be relayed to other vehicles 120A-N. Therefore, controller 156 of vehicle 120C may analyze all the information that it has available to it and determine which information may be most relevant to the driver of vehicle 120E. Based upon that determination, the controller 156 of vehicle 120C may generate a communication signal that it provides to the one or more signaling lights 138 of vehicle 120C to modulate the signaling lights 138 to generate a communications beacon carried by the radiation 148 emanating from vehicle 120C and sensed by the image sensor 146 of vehicle 120E. In one aspect, the determination of what information to send by the controller 156 of vehicle 120C may be based upon the throughput or the bandwidth of the communications between vehicles 120C and 120E. In other words, the controller 156 of vehicle 120C may prioritize information that it has available according to what may be most relevant to the driver of vehicle 120E and then send as much of the information, in the order of priority, up to the communicative link between vehicle 120C and 120E via radiation 148 therebetween and the image sensor 146 of vehicle 120E.

The communications between two vehicles may, in certain aspects, be limited by the frame rate of the image sensor 146 of the vehicle that is sensing radiation 148 from the other vehicle. In other words, in certain aspects, the sampling or the frame rate of the image sensor 146 may be at least twice the frequency of any signal being transmitted via the radiation 148 of any single channel multiplex onto the transmission. Under certain circumstances, if the sampling by the image sensor 146 does not meet the Nyquist criterion, then aliasing errors may occur. In certain aspects, the overall bandwidth of communications between two vehicles 120A-N may be increased by having multiple channels transmitted therebetween. For example, WDM may be used for multiple channels of communication as discussed above. Additionally, having multiple signals sensed from two or more signaling lights may provide for multiple channels of communications. In this embodiment, certain pixels of the image sensor 146 may detect the signal from one signaling light, and other pixels of the image sensor 146 may detect the signal from other signaling lights during each frame of the image sensor 146. In one sense, this embodiment may enable a spatial multiplexing scheme. For example, suppose two tail lights and a brake light each are modulated independently with an independent signal, and the image sensor senses each of the three signaling lights with a frame rate of 200 frames per second (fps), resulting in a maximum theoretical data rate of 100 bits per second (bps) from each channel. In this case, the maximum combined data rate may be 300 bps.

The roadway system 100 illustrated in FIG. 1 is provided by way of example only. Embodiments of the disclosure may be utilized in a wide variety of suitable environments, including other roadway environments. These other environments may include any number of vehicles. Additionally, each vehicle may include more or less than the components illustrated in FIG. 1.

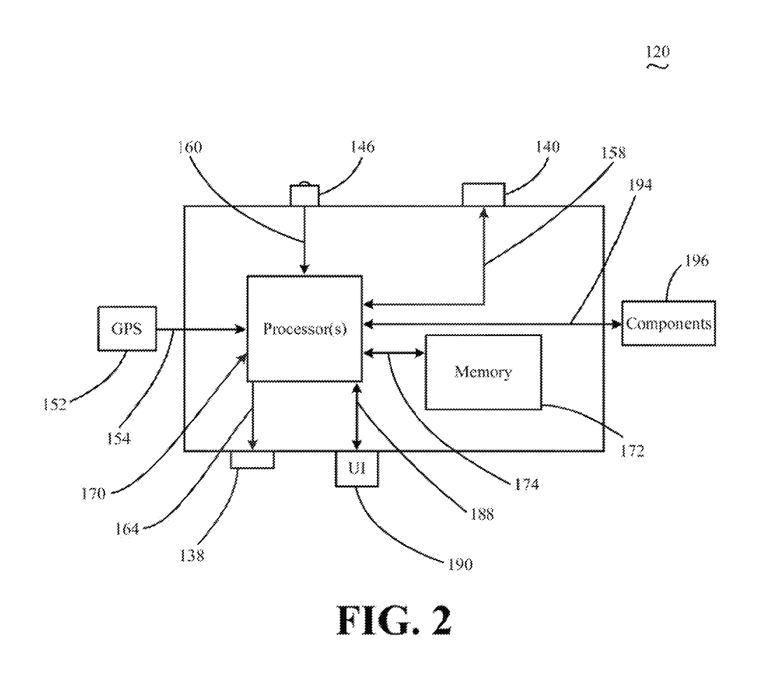

Referring now to FIG. 2, an example controller 156 for inter-vehicle communications in accordance with embodiments of the disclosure is illustrated. The controller 156 may include one or more processors 170 communicatively coupled to any number of suitable memory devices (referred to herein as memory 172) via at least one communicative link 174. The one or more processors 170 may further be communicatively coupled to the image sensor 146 and receive image sensor signals generated by the image sensor 146 via at least one communicative link 160. Additionally, the one or more processors 170 may be communicatively coupled to the range sensor 140 and receive range sensor signals generated by the range sensor 140 via at least one communicative link 158. Further yet, the one or more processors 170 may be communicatively coupled to the navigation system 152 via at least one communicative link 154 and receive navigation system signals generated by the navigation system 152. The controller 156 may further include at least one communicative connection 188 to a user interface 190. The one or more processors 170 may optionally be communicatively coupled to one or more components 196 of the vehicle via at least one communicative path 194. Although separate communicative links and paths are illustrated in FIG. 2, as desired, certain communicative links and paths may be combined. For example, a common communicative link or data bus may facilitate communications between any number of components.

The one or more processors 170 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The controller 156 may also include a chipset (not shown) for controlling communications between the one or more processors 170 and one or more of the other components of the controller 156. In certain embodiments, the controller 156 may be based on an Intel® Architecture system, and the one or more processors 170 and chipset may be from a family of Intel® processors and chipsets, such as the Intel® Atom® processor family. The one or more processors 170 may also include one or more application-specific integrated circuits (ASICs) or application-specific standard products (ASSPs) for handling specific data processing functions or tasks.

In certain embodiments, the controller 156 may be a part of a general vehicle main computer system. The main computer system may in one aspect manage various aspects of the operation of the vehicle, such as engine control, transmission control, and various component controls. Therefore, in such embodiments, the controller 156 may share resources with other subsystems of the main vehicle computer system. Such resources may include the one or more processors 170 or the memory 172. In other embodiments, the controller 156 may be a separate and stand-alone system that controls inter-vehicle communications and information sharing. Additionally, in certain embodiments, the controller 156 may be integrated into the vehicle. In other embodiments, the controller 156 may be added to the vehicle following production and/or initial configuration of the vehicle.

The memory 172 may include one or more volatile and/or non-volatile memory devices including, but not limited to, magnetic storage devices, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read-only memory (EEPROM), non-volatile RAM (NVRAM), universal serial bus (USB) removable memory, or combinations thereof. In one aspect, the software or instructions that are executed by the one or more processors 170 for inter-vehicle communications may be stored on the memory 172.

The user interface 190 may be any known input device, output device, or input and output device that can be used by a user to communicate with the one or more processors 170. The user interface 190 may include, but is not limited to, a touch panel, a keyboard, a display, a speaker, a switch, a visual indicator, an audio indicator, a tactile indicator, a speech to text engine, or combinations thereof. In one aspect, the user interface 190 may be used by a user, such as the driver of the vehicle 120, to selectively activate or deactivate inter-vehicle communications. In another aspect, the user interface 190 may be used by the user to provide parameter settings for the controller 156. Non-limiting examples of the parameter settings may include power settings of the controller 156, the sensitivity of the range sensor 140, the optical zoom associated with the image sensor 146, the frame rate of the image sensor 146, the brightness of the display-related user interfaces 190, such as display screens, the volume of the one or more audio-related user interfaces 190, such as a speaker, other parameters associated with user interfaces 190, and other parameters associated with the controller 156. The user interface 190 may further communicate with the one or more processors 170 and provide information to the user, such as an indication that inter-vehicle communications are operational.

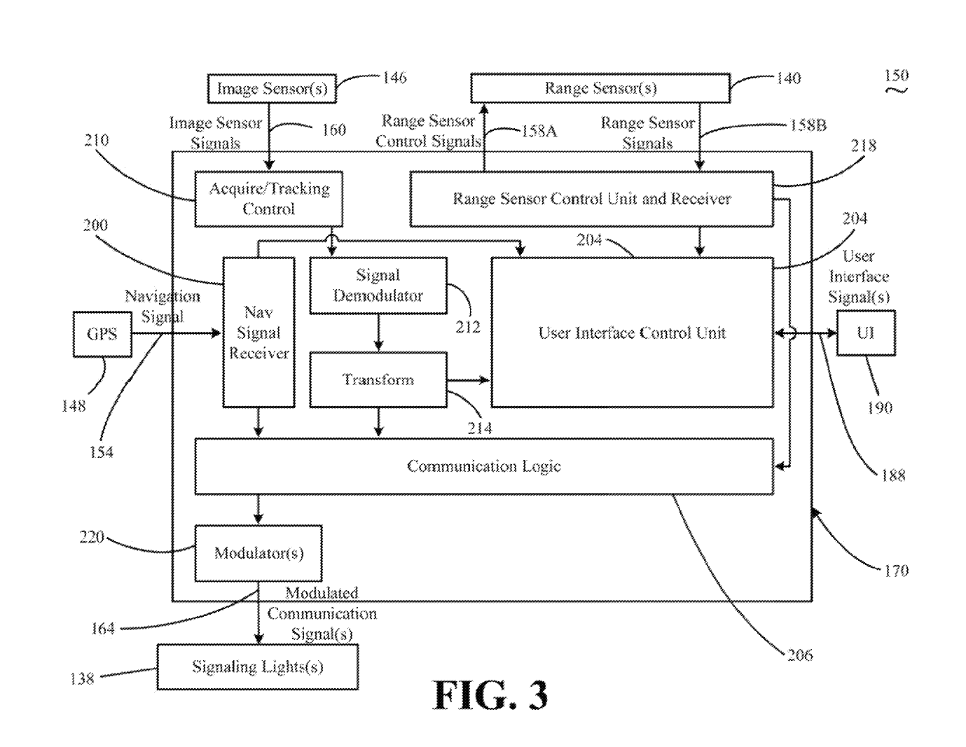

Referring now to FIG. 3, an example illustrative functional block diagram of the one or more processors 170 for controlling inter-vehicle communications is shown. The one or more processors 170 may include a navigation signal receiver 200 communicatively coupled to a user interface control unit 204 and a communication logic block 206. The one or more processors 170 may further include an acquire and tracking control 210, communicatively coupled to a signal demodulator 212, and further communicatively coupled to a transform block 214, that may yet further be communicatively coupled to the user interface control unit 204 and the communication logic block 206. The one or more processors 170 may yet further include a range sensor control unit and receiver 218 that may be communicatively coupled to the user interface control unit 204 and the communication logic block 206. Included also in the one or more processors 170, one or more modulators 220 may be communicatively coupled to the communication logic block 206 and may provide modulated communication signals to the one or more signaling lights 138.

During operation, the one or more processors 170 may receive the image sensor signals by detection of radiation 148 from one or more other vehicles 120A-N via the acquire and tracking control 210. From the received image sensor signal, the acquire and tracking control 210 may isolate a subset of pixels from images corresponding to the image sensor signals that can be analyzed to determine the communication signal transmitted from one or more other vehicles 120A-N. For example, the acquire and tracking control 210 may analyze each frame of images received from the image sensor 146 and using a variety of methods may isolate the pixels corresponding to the images of the one or more signaling lights 138. By doing so, the modulation of the signaling lights may be determined by the one or more processors 170. In one aspect, the acquire and tracking control 210 may first determine if the images received from the image sensor 146 contain images of one or more signaling lights 138 of another vehicle 120A-N and isolate the pixels corresponding to an image of one or more signaling lights 138 if the same exists.

Once the acquire and tracking control 210 determines the modulated indication signal from the images provided by the image sensor 146, the signal demodulator 212 may demodulate the modulated signal. In one aspect, the signal demodulator 212 may be aware of the modulation scheme of the radiation 148. Alternatively, the signal demodulator 212 may analyze the communication signal to determine the modulation of the same. The signal demodulator 212 may next provide the demodulated communication signal to the transform block 214, and the transform block may determine or extract the communicated information from another vehicle 120A-N.

The communicative information from the transform block 214 may be provided to the user interface control unit 204. The user interface control unit 204 may also receive range sensor information from the range sensor 140 via the range sensor control unit and receiver 218. Additionally, the user interface control unit 204 may receive navigation signals and information from the navigation signal receiver 200. From the information received by the user interface control unit 204, the user interface control unit 204 may select a subset thereof based upon software running thereon providing logic associated with which information may be most useful to a user of the vehicle. The user interface control unit 204 may then generate user interface signals and provide the same to the one or more user interfaces 190. In one aspect, the user interface signals may be display signals, audio signals, haptic signals, or combinations thereof.

The range sensor control unit and receiver 218 may both receive range sensor signals via communicative path 158B and send control instructions to the range sensor 140 via communicative path 158A. Therefore, the range sensor control unit and receiver 218 not only receives range sensor input, but may also control the operation of the range sensor 140. In one aspect, the range sensor control unit and receiver 218 may instruct the range sensor 140 on when to acquire a range measurement.

The navigation information from the navigation signal receiver 200, the communicated information from transform block 214, and the range sensor information from the range sensor control unit and receiver 218 may be provided to the communication logic block 206. In addition, the communication logic block 206 may have vehicle information available to it. The communication logic block 206, using software running thereon providing logic, may determine which information available to it may be relevant to another vehicle 120A-N. In other words, the communication logic block 206 may select a subset of the information available to it from the various sources and provide this information to the one or more modulators 220. The one or more modulators 220 may generate modulated communication signals and provide the same to the one or more signaling lights 138. In one aspect, the communication logic block 206 may consider the bandwidth or throughput associated with the one or more signaling lights 138 in determining what information to send thereon.

In certain embodiments, the information provided to the user interface 190 by the user interface control unit 204 may be the same information that is communicated via the communication logic block 206 via modulated communication signals from the one or more modulators 220. In other embodiments, the information provided to the user interface 190 by the user interface control unit 204 may be different from the information that is communicated via the communication logic block 206 via modulated communication signals from the one or more modulators 220.

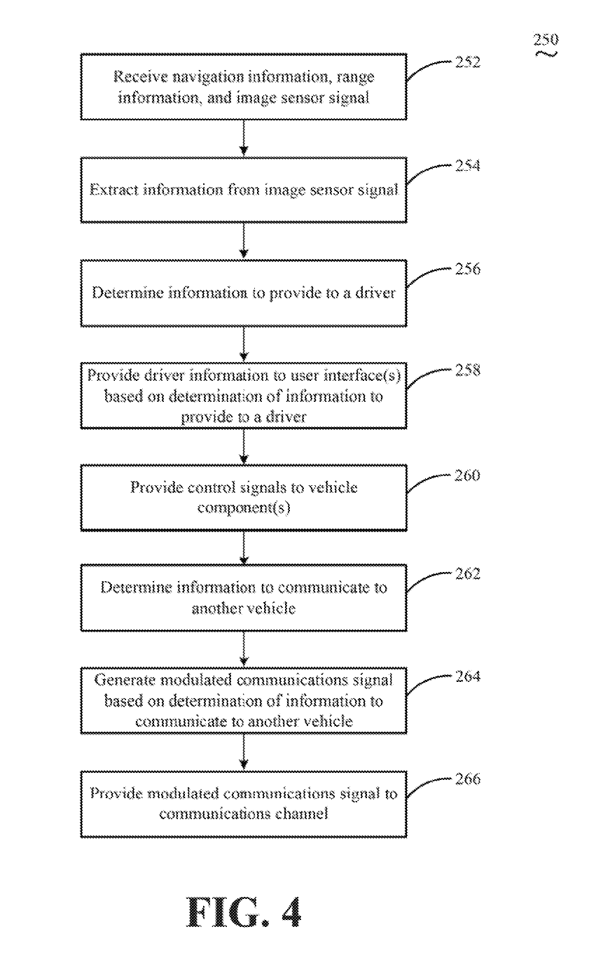

Referring now to FIG. 4, an example method 250 for providing modulated communication signals to a communications channel is illustrated. At block 252, navigation signals, range information, and image sensor signals are received. As highlighted above, the signals may be received by one or more processors 170 and constituent functional blocks thereof.

At block 254, information may be extracted from the image sensor signal, as described with reference to FIG. 3. In particular, the signal demodulator 212 may demodulate the signal from the image sensor 146 and provide the same to the transform block 214 to extract the information from the demodulated image sensor signal.

At block 256, the information to provide to the user of the vehicle, such as the driver, may be determined. In this case, the information to provide to the driver may be a subset of all the information available to the one or more processors 170 from various sources including the image sensor 146, the range sensor 140, and the navigation system 152.

At block 258, the information selected for providing to the driver may be provided to the driver via user interfaces. As described in conjunction with FIG. 3, the user interface control unit 204 may generate user interface signals and provide the same to one or more user interfaces 190.

At optional block 260, one or more control signals may be provided to one or more components of the vehicle. The one or more processors 170, may, therefore, control one or more of the components 196 of the vehicle based on information available to it from the image sensor 146, the range sensor 140, and the navigation system 152. In one aspect, the one or more components may include brakes, engine, transmission, fuel supply, throttle valve, clutch, or combinations thereof of the first vehicle 120A-N. As a non-limiting example, the one or more processors 170 may determine, based on the information available to it, that one or more vehicles 120A-N in front are decelerating rapidly and that the driver may not be aware of this deceleration. In that case, the one or more processors 170 may provide component control signals in the form of a braking command to cause the brakes to be applied and thereby slow down the vehicle responsive to the information available.

At block 262, information to communicate to other vehicles may be determined. As described above, the communication logic block 206 may ascertain which information available to it from various sources may be of use to a driver of another vehicle 120A-N. The communication logic block 206 may further consider the bandwidth of the communications channels or other vehicle information that may be used for communicating to another vehicle 120A-N.

At block 264, the modulated communication signal may be generated. The modulated communication signal may contain the information deemed to be useful by a driver of another vehicle by the communication logic block 206. The modulated communication signal may be generated by the one or more modulators 220.

At block 266, the modulated communication signals may be provided to the communications channel. For example, the one or more modulators 220 may provide the modulated communication signal to the one or more signaling lights 138.

It should be noted, method 250 may be modified in various ways in accordance with certain embodiments of the disclosure. For example, one or more operations of method 250 may be eliminated or executed out of order in other embodiments of the disclosure. Additionally, other operations may be added to method 250 in accordance with other embodiments of the disclosure.

Embodiments described herein may be implemented using hardware, software, and/or firmware, for example, to perform the methods and/or operations described herein. Certain embodiments described herein may be provided as a tangible machine-readable medium storing machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation. In the use of such terms and expressions, there is no intention of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method comprising:
receiving, by at least one processor associated with a first vehicle, data from a second vehicle;
receiving, by the at least one processor, at least one sensor signal providing at least one information element;
generating, by the at least one processor, a user interface signal based on the data from the second vehicle and the at least one sensor signal; and
providing, by the at least one processor, the user interface signal to a user interface.

2. The method of claim 1, wherein receiving data from a second vehicle comprises receiving a modulated signal output by the second vehicle.

3. The method of claim 2, further comprising demodulating, by the at least one processor, the received modulated signal.

4. The method of claim 1, wherein the data from the second vehicle includes at least one of: (i) a velocity of at least one other vehicle; (ii) a position of at least one other vehicle; (iii) an acceleration of at least one other vehicle; (iv) a deceleration of at least one other vehicle; (v) an activation of brakes in at least one other vehicle; (vi) global positioning satellite (GPS) navigation coordinates; or (vii) a distance between two other vehicles.

5. The method of claim 1, wherein the at least one sensor signal comprises a range sensor signal.

6. The method of claim 1, wherein the at least one information element comprises at least one of: (i) a distance between the first vehicle and at least one other vehicle; (ii) global positioning satellite (GPS) navigation information of the first vehicle; (iii) position of the first vehicle; (iv) velocity of the first vehicle; or (v) acceleration of the first vehicle.

7. The method of claim 1, wherein generating a user interface signal further comprises determining, based upon an evaluation of at least one of the data or the at least one information element, information relevant to a driver of the first vehicle.

8. The method of claim 1, further comprising controlling, by the at least one processor, at least one component of the first vehicle based at least in part upon at least one of the data from the second vehicle or the at least one information element.

9. The method of claim 8, wherein controlling at least one component comprises controlling at least one of: (i) brakes of the first vehicle; (ii) an engine of the first vehicle; (iii) a transmission of the first vehicle; (iv) a fuel supply of the first vehicle; (v) a throttle valve of the first vehicle; or (vi) a clutch of the first vehicle.

10. The method of claim 1, further comprising generating, by the at least one processor, a signal to transmit to a third vehicle based at least in part on the data from the second vehicle and the at least one information element.

11. The method of claim 10, wherein generating a signal to transmit to a third vehicle further comprises generating a signal based at least partly on a bandwidth of a channel between the first vehicle and the third vehicle.

12. A vehicle comprising:
a receiver configured to receive a modulated signal output by a second vehicle;
at least one processor communicatively coupled to the receiver and configured to demodulate the modulated signal; and,
a user interface communicatively coupled to the at least one processor and configured to receive a user interface signal generated by the at least one processor based in part on the demodulated modulated signal.

13. The vehicle of claim 12, further comprising a sensor communicatively coupled to the at least one processor and providing a sensor signal.

14. The vehicle of claim 13, wherein the user interface signal generated by the at least one processor is further based in part on the sensor signal.

15. The vehicle of claim 12, wherein the receiver is an image sensor.

16. The vehicle of claim 15, wherein the at least one processor is configured to demodulate the modulated signal by decoding an image generated by the image sensor.

17. The vehicle of claim 12, further comprising a modulator communicatively coupled to the at least one processor and configured to receive a communication signal from the at least one processor.

18. The vehicle of claim 17, wherein the modulator is one of: (i) a tail light of the vehicle; (ii) a reverse light of the vehicle; (iii) a light-emitting diode (LED); (iv) a light emitter; (v) a radio frequency emitter; or (vi) a sonic emitter.

19. The vehicle of claim 17, wherein the communication signal is generated by the at least one processor based at least partly on the demodulated signal, the sensor signal, and a bandwidth of the receiver.

20. At least one computer-readable medium comprising computer-executable instructions that, when executed by one or more processors associated with a vehicle, executes a method comprising:
receiving data from a second vehicle;
receiving at least one sensor signal providing at least one information element;
generating a user interface signal based on the data from the second vehicle and the at least one sensor signal; and
providing the user interface signal to a user interface.

21. The computer-readable medium of claim 18, wherein the method further comprises controlling at least one component of the vehicle based at least partly upon at least one of the data from the second vehicle or the at least one information element.

22. The computer-readable medium of claim 18, wherein the method further comprises generating a signal to transmit to a third vehicle based at least partly on the data from the second vehicle and the at least one information element.
